(19) United States
(12) Patent Application Publication
(10) Pub. No.: US 2004/0030586 A1
(43) Pub. Date: Feb. 12, 2004

(54) System and method for patient clinical data management

(75) Inventors: Peter Cucchiara, New Fairfield, CT (US); Kim Hampton, Carmel, NY (US); Johan Graden, Nacka (SE)

Correspondence Address: LERNER, DAVID, LITTENBERG,, KRUMHOLZ & MENTLIK, 600 SOUTH AVENUE WEST, WESTFIELD, NJ, 07090, US

(73) Assignee: IntegraMed America, Inc., Purchase, NY (US)

(21) Appl. No.: 10/413,968

(22) Filed: Apr. 15, 2003

Related U.S. Application Data
(60) Provisional application No. 60/372,634, filed on Apr. 15, 2002.

(51) Int. Cl. G06F 17/60

(52) U.S. Cl. 705/3

(57) ABSTRACT

The present invention provides a system and method for patient clinical data management. The system and method provide automated data gathering, processing and reporting. Test orders are generated using a patient clinical data management application and are transmitted to laboratory equipment. Test results are obtained by the patient clinical data management application directly from the laboratory equipment. Processing may be performed in conjunction with demographic and related data. Reporting is conducted in accordance with reporting requirements imposed from governmental or other regulatory bodies. Select information from the records may be provided to endpoint devices such as mobile telephones, websites, pagers or personal digital assistants for up to the minute reporting.

### CROSS-REFERENCE TO RELATED APPLICATIONS

This application claims the benefit of U.S. Provisional Patent Application No. 60/372,634, filed Apr. 15, 2002 and entitled SYSTEM AND METHOD FOR PATIENT DATA MANAGEMENT, the entire disclosure and appendices of which are hereby expressly incorporated by reference.

### FIELD OF INVENTION

The present invention relates to medical diagnostics. More particularly, the present invention provides a system and method for patient clinical data management. The system and method are suitable for data collection, diagnostics, analysis, reporting and connectivity to applications across distributed networks.

### BACKGROUND OF THE INVENTION

In the past, medical professionals such as physicians, nurses and laboratory technicians used paper charts to track a patient's history and status. More recently, such professionals have moved away from relying on paper charts. Instead, electronic medical records (“EMR”) and computer-based patient records (“CPR”) are used more and more to leverage all available information to improve medical care.

EMR and CPR records are also known as electronic patient records (“EPR”), virtual patient records (“VPR”) and electronic health records (“EHR”). Regardless of the acronym, these records supplement or totally replace paper charts and records. Medical information systems (“MIS”) use EMR and CPR to maintain up-to-date, robust patient information while reducing the time, labor and other costs associated with managing such data.

Often, data is manually input into EMR and CPR systems, which can prove costly and time-consuming. Such systems may have hundreds or thousands of fields of data per patient record, depending upon, e.g., the physician's area of specialty. For example, a physician involved with assisted reproductive technology (“ART”) may use an EMR or CPR database having on the order of 5,000 fields per record. The fields may include, by way of example only, patient data, laboratory results and treatment information.

In order to fully leverage information stored in the database, it is critical that it be easy to enter, process, retrieve and export the data. Once this is achieved, medical professionals and patients will benefit from current information to achieve better decision-making. Therefore, it is desirable to implement an information system having enhanced inputting, processing and reporting capabilities.

Reporting is important not only for internal use by medical professionals, but also as part of an external procedure that a governmental body or medical society may mandate. Reporting includes generating reports and charts, and formatting data so that a medical professional using the system can analyze the data. It also encompasses producing electronic records that are sent from the system to an external entity. For example, the 1992 Fertility Clinic Success Rate and Certification Act, codified at 42 U.S.C. § 263a-1 et seq., requires ART clinics to report certain fertility-related information to the Centers for Disease Control and Prevention (“CDC”). ART clinics provide data to the CDC through a reporting system of the Society for Assisted Reproductive Technology (“SART”). This system is known as the Clinical Outcome Reporting System (“CORS”).

SART CORS allows ART clinics (e.g., fertility clinics) to automate the reporting process. The reported information is extensive, and includes patient information, patient history, diagnosis, donor and retrieval data, embryo transfers and delivery information. Detailed information about the SART CORS system may be obtained from SART or from Redshift Technologies, Inc., which has implements a SART CORS Import Gateway.

In practice areas, particularly those with heavy regulation and/or detailed reporting requirements, it is important that the patient database and underlying information system are capable of interfacing with off-the-shelf applications and generating standard reports without undue modification. Therefore, it is desirable to provide an enhanced system and method to achieve these goals.

### SUMMARY OF THE INVENTION

In accordance with one embodiment of the present invention, a computer-implemented method for managing patient clinical data is provided. The method comprises interfacing a central computer with laboratory equipment. The central computer has access to patient clinical data stored in a patient information database. The laboratory equipment is operable to generate test results based on medical tests. The test results are received from the laboratory equipment at the central computer. The test results are stored as a test results portion of the patient clinical data in the patient information database. A subset portion of the patient clinical data, including data from the test results portion, is selected in accordance with predetermined selection criteria. The selected subset portion of the patient clinical data is reported to a reporting device. Preferably, interfacing further includes sending a request to conduct the medical test from the central computer to the laboratory equipment. The laboratory equipment may be controllable by a client computer which is remote from the central computer and the laboratory equipment. The client computer may receive the test results, and then transfer the test results to the central computer.

In one example, the predetermined selection criterion is identified using one of several selections, including a user-generated selection, a system-generated selection, or a by-directional selection. Preferably, the test results include endocrine tests results for use in fertility treatment. More preferably, the subset portion includes endocrine data from the endocrine test results. The method preferably further comprises associating partner information with the patient clinical data such that a patient in the patient information database is linked with a partner. Thus, the user can thereby obtain a report and document treatment for the patient and for the partner. In another alternative, the predetermined selection criterion is a SART-compliant format, and the subset portion of the patient clinical data is reported according to the SART-compliant format. In another alternative, the method further comprises obtaining back office information from a back office server. The back office information is incorporated as a second portion of the patient clinical data in the patient information database. In this alternative, the subset portion further includes at least a portion of the back office information.

In accordance with another embodiment of the present invention, a computer implemented method for managing patient clinical data is provided. The method includes sending a request to conduct a medical test from a central computer to laboratory equipment that is used in connection with patient testing. A central computer has access to the patient clinical data that is stored in the patient information database. The central computer receives test results from the laboratory equipment. The test results are based on the medical test. The test results are stored as a test results portion of the patient clinical data in the patient information database. A subset portion of the patient clinical data, including data from the tests results portion, is selected in accordance with predetermined selection criteria. A report of the selected subset portion of the patient clinical data is also generated. In one alternative, the medical test is test on a patient sample. In another alternative, the medical test is a batch of tests on a patient sample. In a further alternative, the medical test is a test on a plurality of patient samples. In yet another alternative, the medical test is a batch of tests on a plurality of patient samples. Preferably, the predetermined selection criterion is identified using one of a user-generated selection, a system-generated selection or a by-directional selection. The test results preferably include endocrine tests results for use in fertility treatment.

The report may be generated for a computer remote from the central computer, or for a wireless device. Alternatively, the report is electronically sent to a reporting device. Preferably, the report is generated in a SART-compliant format and the reporting system is a SART reporting system.

In accordance with another embodiment of the present invention, a system for managing patient clinical data is provided. The system comprises a patient information database, laboratory equipment and a central computer. The patient information database is for storing patient clinical data. The laboratory equipment is used in connection with patient testing. It is operable to perform a medical test and generate test results based on the medical test. The central computer is in communication with the laboratory equipment. The central computer includes a patient clinical data management program or application, which is capable of obtaining the test results from the laboratory equipment and performing other operations. These operations include storing the test results as a test results portion of the patient clinical data in the patient information database. The program also selects a subset portion of the patient clinical data, including data in the test results portion, in accordance with predetermined selection criteria. Furthermore, the subset portion of the patient clinical data is transmitted to a recording device. The central computer preferably includes an application server for running the patient clinical data management program. The system preferably further comprises a client computer operable to access the patient clinical data management program by connecting to the application server. Preferably, the client computer receives the test results from the laboratory equipment, and the client computer is operable to transfer the test results to the patient clinical data management program. The client computer is remote from the laboratory equipment and the central computer.

The test results preferably endocrine test results are used for fertility treatment. optionally, the reporting device is an endpoint device operable to interface with the central computer and receive the subset portion of the patient clinical data. The endpoint device may be a computer, a personal digital assistant, a wireless telephone, a pager or a website. In one alternative, the system further comprises a back office server for managing back office information related to patient records. The back office server is capable of providing the back office information to the central computer for use by the patient clinical data management program. In this alternative, the patient clinical data management program is operable to incorporate the back office information as a second portion of the patient clinical data in the patient information database. The subset portion, in this case, further includes at least a part of the second portion of the patient clinical data. In another alternative, the patient clinical data management program is capable of coupling partner information with the patient clinical data such that patients in the patient information database are properly associated with partners. In a further alternative, the system further comprises a CORS reporting system. In this case, the patient clinical data management application is capable of transmitting the subset portion to the CORS reporting system in a SART-compliant format.

In a further embodiment of the present invention, a system for managing patient clinical data is provided. The system comprises a patient information database, laboratory equipment and a central computer. The patient information database stores the patient clinical data. The laboratory equipment is used in connection with patient testing and is operable to perform medical tests and generate test results based on the medical test. The central computer is in communication with the laboratory equipment. It has access to the patient information database and it includes a patient clinical data management program that is capable of sending a request to conduct the medical test to the laboratory equipment. The patient clinical data management program is also capable of receiving the test results from the laboratory equipment, storing the test results as a test results portion of the patient clinical data of the patient information database, selecting a subset portion of the patient clinical data, including data from the test results portion, in accordance with predetermined selection criteria, and is capable of generating a report of the selected subset portion of the patient clinical data. Preferably the central computer includes an application server for running the patient clinical data management program. The system in this case further comprises a client computer operable to access the patient clinical data management program by connecting to the application server. In an alternative, the client computer receives the test results from the laboratory equipment. In this situation the client computer is operable to transfer the tests results to the patient clinical data management program. The client computer is remote from the laboratory equipment and the central computer.

Preferably, the test results include endocrine test results for use in fertility treatment. In one example, the reporting device is an endpoint device, which is able to interface with the central computer and receive the subset portion of the patient clinical data. The endpoint device may be a computer, a personal digital assistant, a wireless telephone, a pager or a website.

Optionally, the system may further comprise a back office information server for managing back office information related to patient records. The back office information server is capable of providing the back office information to the central computer for use by the patient clinical data management program. The patient clinical data management program is operable to incorporate the back office information as a second portion of the patient clinical data in the patient information database. In this alternative, the subset portion further includes at least part of the second portion of the patient clinical data.

In another alternative, the patient clinical data management program is capable of coupling partner information with the patient clinical data such that patients in the patient information database are correctly associated with partners. In another alternative, the system further comprises a CORS reporting system. Here, the patient clinical data management program is capable of transmitting the subset portion of the patient clinical data to the CORS reporting system in a SART-compliant format.

In another embodiment of the present invention, a computer-usable storage medium is provided. The storage medium stores a program capable of instructing a processor to execute certain actions. An action is interfacing a central computer with laboratory equipment. The central computer has access to patient clinical data stored in a patient information database. The laboratory equipment is operable to generate test results based on medical tests. Another action is the central computer receiving the test results from the laboratory equipment. A further action is storing the test results as a test results portion of the patient clinical data in the patient information database. The actions also include selecting a subset portion of the patient clinical data, including data from the test results portion, in accordance with predetermined selection criteria. Yet another action is reporting the selected subset portion of the patient clinical data to a reporting device.

In accordance with another embodiment of the present invention, a computer-usable storage medium is provided. The storage medium stores a program capable of instructing a processor to execute certain actions. One action is sending a request to conduct a medical test from a central computer to laboratory equipment that is used in connection with patient testing. The central computer has access to patient information stored in a patient information database. Another action is receiving test results at the central computer from the laboratory equipment. The test results are based on the medical test. A further action is storing the test results as a test results portion of the patient clinical data in the patient information database. Another action is selecting a subset portion of the patient clinical data, including data from the test results portion, in accordance with predetermined selection criteria. Yet another action is generating a report of the selected subset portion of the patient clinical data.

### BRIEF DESCRIPTION OF THE DRAWINGS

FIG. 1 illustrates a diagram of a medical information system in accordance with an embodiment of the present invention.

FIG. 2 illustrates a user-generated order system GUI.

FIG. 3 illustrates a graphical user interface (“GUI”) for sending a laboratory test.

FIGS. 4A-B illustrate GUIs for generating barcode labels for use with medical testing.

FIG. 5 illustrates a GUI having color-coded laboratory test results.

FIGS. 6A-B illustrate GUIs for displaying received laboratory test results.

FIG. 7 illustrates an example of a medical report in accordance with the present invention.

FIG. 8 illustrates a GUI for sending real-time messages pertaining to laboratory test results.

FIG. 9 illustrates a diagram of a medical information system in accordance with another embodiment of the present invention.

FIGS. 10A-D illustrate GUIs for patient demographic information.

FIGS. 11A-C illustrate GUIs pertaining to patient history and treatment.

FIGS. 12A-B illustrate exemplary reports generated in accordance with the present invention.

### DETAILED DESCRIPTION

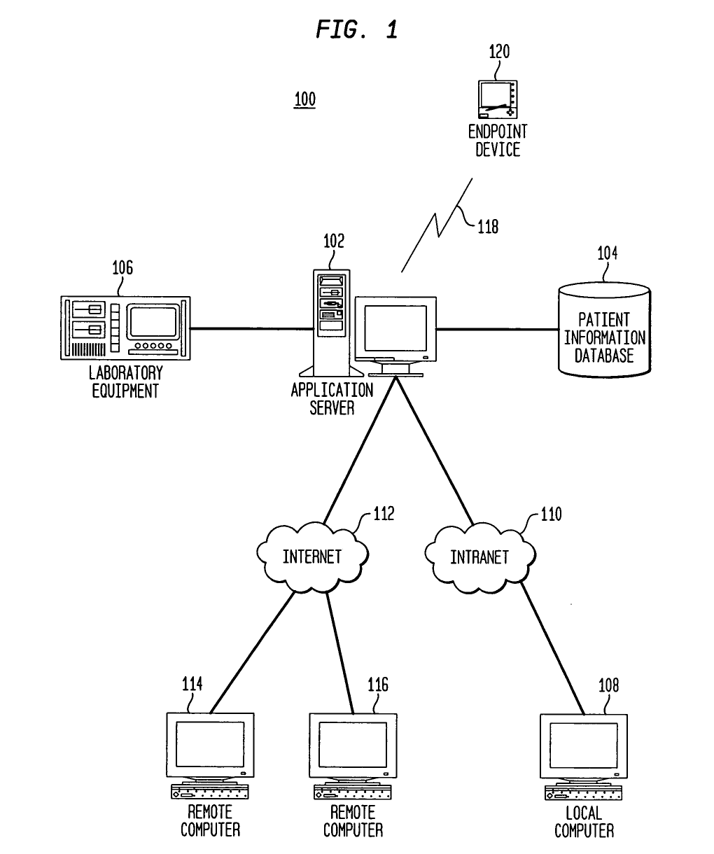

The present invention will now be described in relation to the figures, wherein like numerals represent like elements. FIG. 1 illustrates a system 100 in accordance with one embodiment of the present invention. The system 100 includes an application server 102, a patient information database 104, laboratory equipment 106, a local computer 108, remote computers 114 and 116 and an endpoint device 120. The local computer 108 may be remote from the application server 102 and may connect to it through an Intranet 110 or other well-known methods. As used herein with regard to computers and other devices, being “remote” from equipment, e.g., the application server 102 or the laboratory equipment 106 means physically separate from the equipment. The devices may be in communication with the equipment either wirelessly or via a wired connection and still be considered remote from that equipment. The remote computers 114 and 116 may connect to the application server 102 through the Internet 112 or through other means such as private networks, direct dial-in, etc. The remote computers 114 and 116 may be associated with one another or may operate separately as in, for example, one or more medical clinics. The endpoint device 120 preferably connects to the application server 102 via a network 118, which may be a wired or wireless network. Although only a few computers and devices are depicted in FIG. 1, it should be appreciated that a typical system 100 can include a large number of connected computers and devices.

Preferably, the local computer 108 and the remote computers 114 and 116 are general-purpose computers having all the internal components normally found in a personal computer. More preferably, the local computer 108 and the remote computers 114 and 116 are capable of supporting a window-based graphical user interface (GUI). The local computer 108 and the remote computers 114 and 116 may communicate using a modem or other communication components such as a network card, including a wireless LAN card. The endpoint device 120 may comprise any device capable of processing instructions and transmitting data to and from humans and computing devices, such as a personal digital assistant (“PDA”), wireless telephone (e.g., a cellular or PCS-frequency telephone), pager, website, handheld or portable computer and the like.

The application server 102 contains software and hardware for sending and receiving information over the Internet and other networks. The application server 102 may be a conventional application server or any computer network server or other automated system capable of communicating with other computers over a network. The application server 102 may comprise one or more distributed processors.

In one alternative of the invention, the application server 102 contains a patient clinical data management application or program resident in memory of the application server 102. The terms application and program are used interchangeably herein. The application preferably operates on data stored in the patient information database 104. The functions, methods and routines of the application are explained in detail below. It should be appreciated that certain actions of the application may be performed in different order.

The patient information database 104 may be included with or remote from the application server 102. Although the invention is not limited to any particular database structure, the data maintained by the patient information database 104 may be stored as a table having a plurality of different fields and records. For example, a patient record may have hundreds or thousands of fields. Each patient record may be indexed and stored according to one or more fields in the record, such as the patient's last name. Alternatively, the data may also be stored using completely different methods of storing information such as XML or the like.

The laboratory equipment 106 may include one or more pieces of equipment, including diagnostic equipment. The laboratory equipment 106 may be, for example, standard medical equipment such as an EKG or EEG machine. The laboratory equipment 106 is preferably capable of generating test results, including laboratory data associated with a patient. In a preferred embodiment, the laboratory equipment 106 provides test results on tissue or other samples for use in a medical specialty. For example, in a system intended for use with fertility treatment, the laboratory equipment 106 is preferably capable of performing endocrine-related testing. By way of example only, one type of such laboratory equipment 106 is the IMMULITE® 2000, provided by Diagnostic Products Corporation. The IMMULITE® 2000 is capable of performing up to 200 tests per hour and supports remote ordering of tests. The laboratory equipment 106 includes hardware for sending and receiving information over the Internet or other networks, and is preferably capable of interfacing with the patient clinical data management application through the application server 102, the local computer 108 and the remote computers 114 and 116.

The patient clinical data management application preferably interfaces with the laboratory equipment 106 in one of the following manners. In a first alternative, the “system-generated option,” the patient clinical data management application automatically generates orders for the laboratory equipment 106 based upon user input. In a second alternative, the “user-generated option,” a user such as a medical practitioner operates the patient clinical data management application to generate orders, e.g., test requests, for the laboratory equipment 106. As a general matter, users may access the application through remote computers 114 and 116, local computer 108, or directly at the application server 102. Optionally, a user may access the application from the endpoint device 120, which may be, e.g., a two-way pager or PDA with access to the Internet. As a preferred example, the patient clinical data management application includes a GUI accessible by the users. In a third alternative, the “bi-directional option,” all data entry into the laboratory equipment 106 is automated. Each alternative will now be explained in more detail.

In the system-generated option, the user enters an order request into the patient clinical data management application. The application automatically generates the order. The order is manually entered at the laboratory equipment. Once the laboratory equipment 106 generates test results, the laboratory equipment 106 interfaces directly with the application server 102 to provide the test results to the patient clinical data management application. As mentioned above, in this option the application automatically generates orders for use by the laboratory equipment 106. These orders may include, by way of example only, requests to perform specific tests. Because the application generates orders without user entry, there is an increase in efficiency and a reduction of potential typographical errors. Users may access the test results, and are able to generate reports, medical charts and graphs. Furthermore, users may view released and unreleased information related to test orders. Released information includes test results provided by the laboratory equipment 106 to the patient clinical data management program, while unreleased information includes data that is also provided by laboratory equipment, but may not be accessible to certain users. In the case where the laboratory equipment 106 generates endocrine results, users may view released and unreleased endocrine values.

The user-generated option allows users to control input to the laboratory equipment 106 and tailor the information as desired. Users may perform one or more of the following exemplary actions in the user-generated option: place an order, input an individual test request, order a panel of tests, delete an order, verify that an order is placed, view historical laboratory data by specific patient, place a “provisional” order, convert a provisional order and work with an unreleased view. A provisional order is a test to be performed at a later or unknown date. Test results are sent from the laboratory equipment 106 to the application in the same manner as in the system-generated option, e.g., manually input into the laboratory equipment 106. Once the test results are ready, the user manually retrieves the test results from the laboratory equipment 106 and enters the information into the patient clinical data management program.

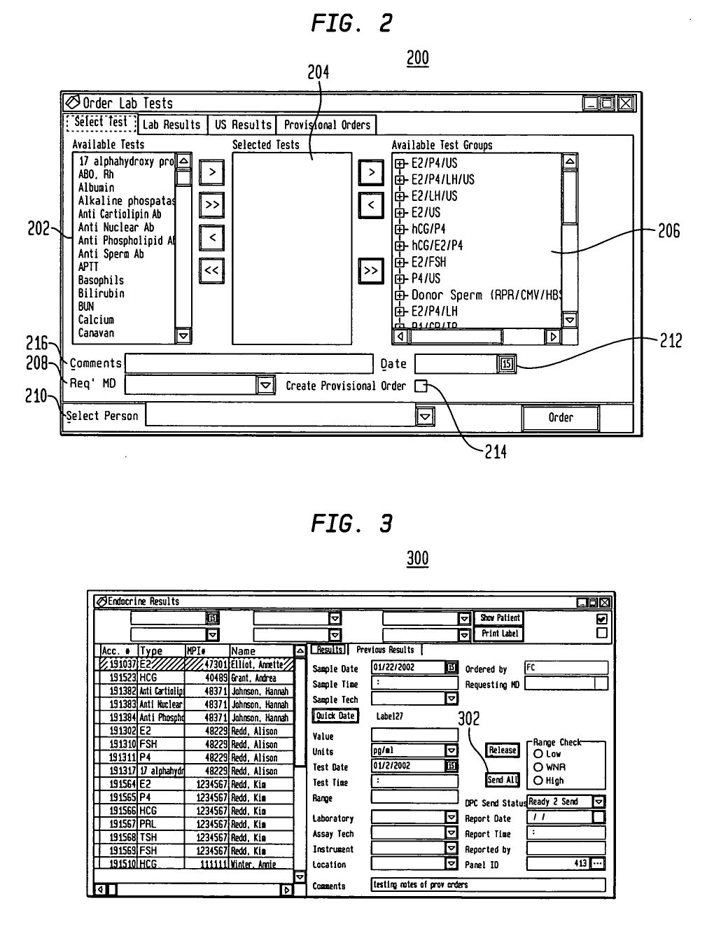

FIG. 2 illustrates a graphical user interface (GUI) screen-shot 200 of a program used for user-generated ordering of tests. As shown on the left hand side of the GUI, a user may select an individual test from among the choices provided in the left column 202. Once selected, the test is moved into the center column 204 of the GUI 200, entitled “Selected Tests.” As an alternative, the user may select a group, or panel of tests from the right hand column 206 of the GUI 200. Optionally, the user may select one or more individual tests from among the panels of tests. The requesting doctor is identified by “Req' MD” field 208. The user may select a patient or her partner in “Select Person” field 210. More details about coupling patient and partner information will be provided below. Preferably, the user may select one or more patients. Selecting check box “Create Provisional Order” 214 places a provisional order. The date of the provisional or actual order is entered via “Date” field 212. Any comments, such as an explanation of a provisional order, may be entered in the text box labeled “Comments” 216.

Tests ordered during the same transaction are preferably automatically grouped in the same panel identifier (“Panel ID”). Tests ordered in different transactions are preferably grouped in different Panel IDs. FIG. 3 illustrates a sample GUI screen 300 for a panel of orders ready to send to the laboratory equipment 106. Clicking on “Send All” button 302 causes the application to transmit the order for the selected test(s) to the laboratory equipment 106.

The bi-directional option eliminates the need for manual data entry into the laboratory equipment 106 when an order is generated using the patient clinical data management application. Once the user places the order request in the system, the bi-directional process is totally automatic. The order is automatically generated and provided to the laboratory equipment by the patient clinical data management program. As with the system-generated option, when the test results are ready, the laboratory equipment 106 interfaces directly with the application server 102 to provide the test results to the patient clinical data management application.

The application may print barcode labels or similar identifying labels when generating an order, or such labels may be printed at a later time based on user workflow needs. Barcode labels eliminate two manual functions. One function is the manual creation of a test tube label. The other function is manual order entry into lab equipment. With the barcode label, the laboratory equipment 106 reads the order from the barcode label and compares it to the data from the patient clinical data management application for validity. All labels, barcode or otherwise, in all cases, are preferably selection options and are affixed either to a specifically required. submission object (e.g., a test tube) or other designated object that requires labeling.

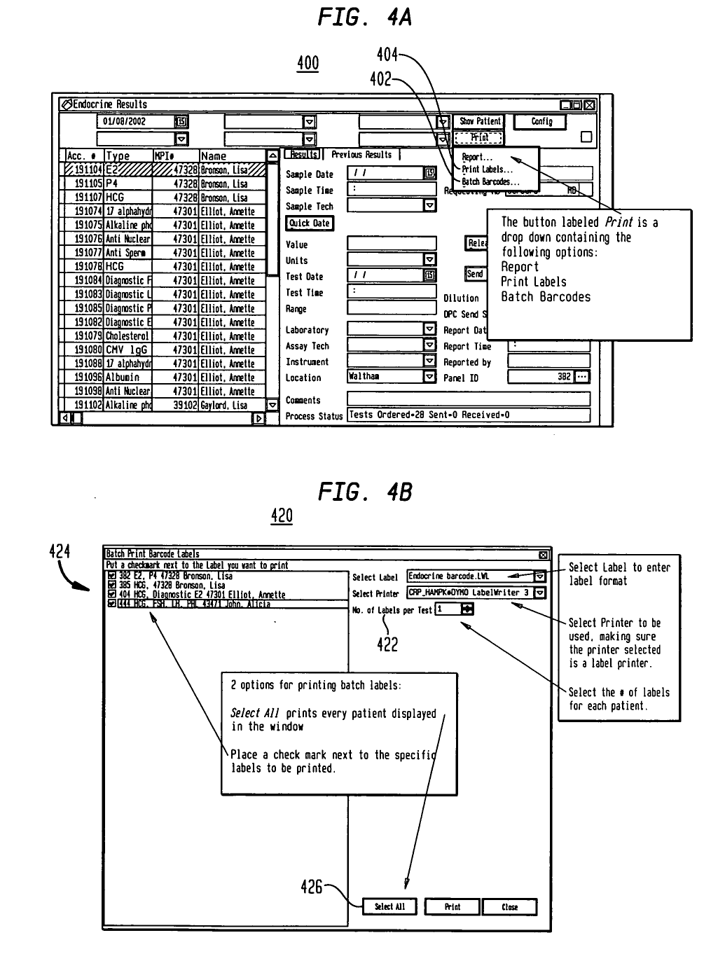

FIGS. 4A and B illustrate GUIs 400 and 420 for generating barcode labels. As shown in the GUI 400 of FIG. 4A, the user may print one or more labels by selecting the option “Batch Barcodes” 402. The option “Print Labels” 404 is used to print the labels. As shown in FIG. 4B, the GUI 420 is provided after selecting Print Labels 404. Here, the user may input the number of labels using the “No. of Labels per Test” 422 entry box. The user may also select which tests to run in batch mode by placing a check mark next to the appropriate tests as shown by arrow 424. Barcode labels may be printed for every patient displayed in the window by choosing the “Select All” button 426.

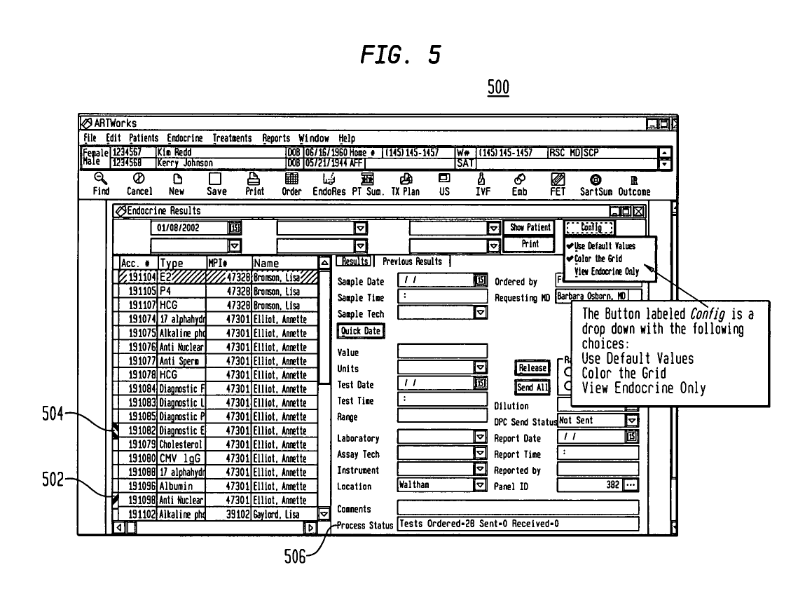

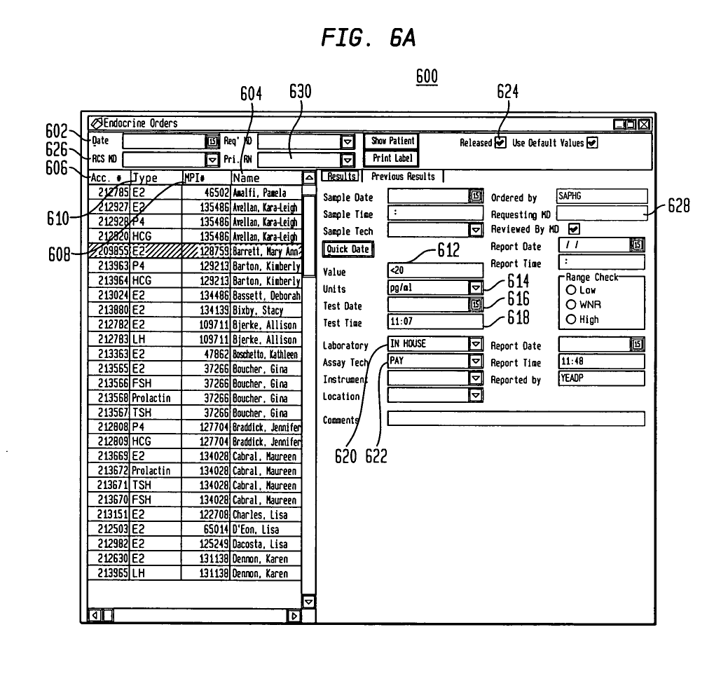

The bi-directional option has the same benefits of the automated system-generated option, particularly increasing efficiency by avoiding user input of received test results from the laboratory equipment 106. Furthermore, this option permits automated distribution of results to, e.g., the remote computers 114 and 116, the local computer 108 or to the endpoint device 120. Because the bi-directional option employs barcode labels, it further enhances gathering, processing and reporting of data. This option allows grouping of panels of tests ordered at different times, and may use color-coding as part of a GUI display to increase workflow efficiency. For example, FIG. 5 illustrates a GUI 500, wherein, when new results are received from the laboratory equipment 106, a color-coded identifier 502 changes color from an initial color 504. While the initial color 504 and the color-coded identifier 502 are shown using shading, any color or color combination, including shading and the like may be used. Thus, a user may readily identify receipt of new test results and act accordingly. The process status field 506 provides the tests ordered, the tests sent and the tests received, so that a user may know the current testing status.

Once the laboratory equipment 106 performs the test(s), results are sent back to the patient clinical data management application. Regardless of the option used to generate an order/test, the user is able to view the information received from the laboratory equipment 106. The test results/laboratory data may encompass a wide variety of information. Some of the information pertaining to the results may be provided from the laboratory equipment 106 to the patient clinical data management application, while the laboratory equipment 106 may not transmit other portions of the information. This information may not need to be transmitted because the patient clinical data management application may, e.g., already have such information stored in the patient information database 104.

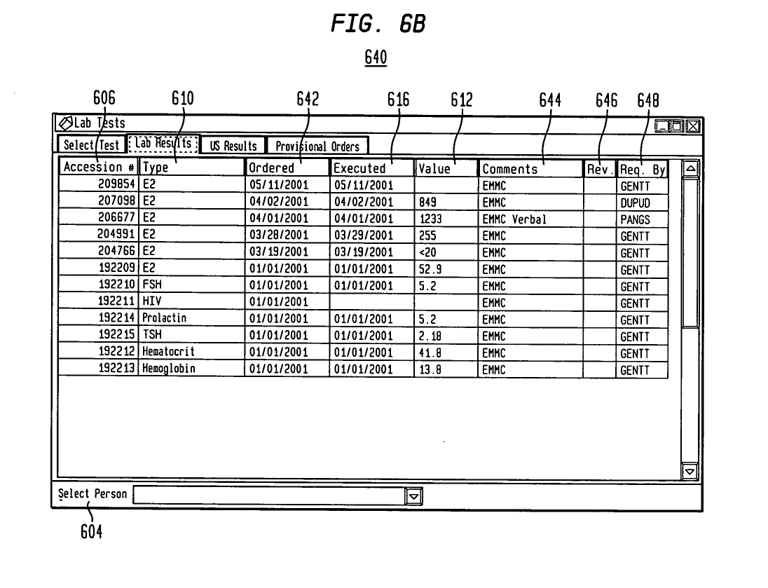

FIG. 6A illustrates a GUI 600 for viewing test results. In the present exemplary snapshot for the GUI 600, the test results are endocrine-related test results for use in fertility testing. By way of example only, the information sent to the patient clinical data management application preferably includes fields for the viewing date 602, the patient name 604, an accession number (“Acc. #”) 606, a master patient index (“MPI”) number 608, the name of the test (“Type”) 610, the test result (“Value”) 612, unit of measurement (“Unit”) 614, test date 616 and test time 618. The accession number 606 is a system-assigned sequence number for handling the test result, which the laboratory equipment 106 may generate. The MPI number 608 serves as a unique patient identifier. The name of the test 610 may be an acronym such as E2 (Estradiol), P4 (Progesterone), LH, TSH, FSH, HCG etc. The unit of measurement 614 may be, e.g., pg/ml. The test date 616 is the date the test was run and the result released to the patient clinical data management application. The test time 618 is the time the result was completed on the lab equipment 106.

As noted above, some of the information pertaining to a particular test result may not be shared with certain users of the patient clinical data management application. Such information may include the laboratory name 620, the assay technician 622, whether information was released 624, the patient's primary doctor 626, the requesting doctor 628 and the primary nurse 630.

Optionally, the patient clinical data management application provides users with an historical view of test results. FIG. 6B illustrates an historical view GUI 640. In one alternative, the historical view GUI 640 is read only. Similar to the GUI 600, the GUI 640 provides the patient name 604, the accession number 606, the Type 610, the Value 612 and the test date 616. The GUI 640 may also provide the order date 642 of the test, any comments 644, the reviewer 646 (if any) of the test results, and the requester 648 of the test(s).

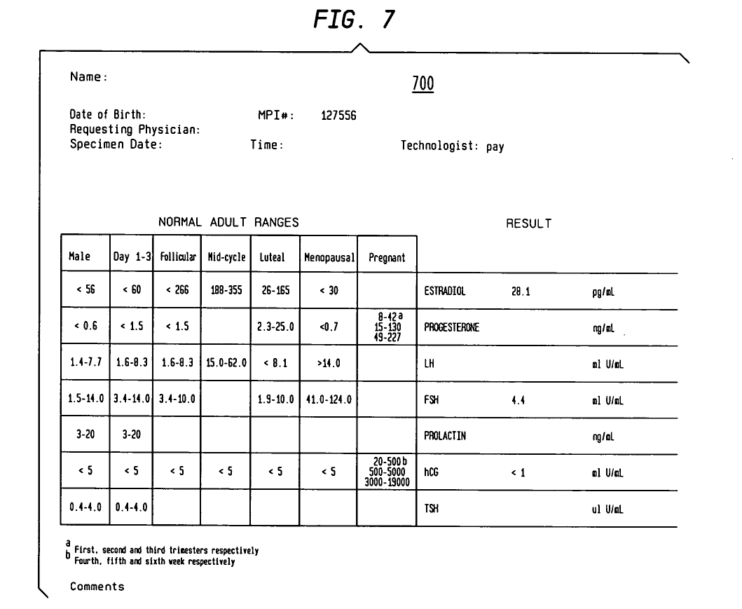

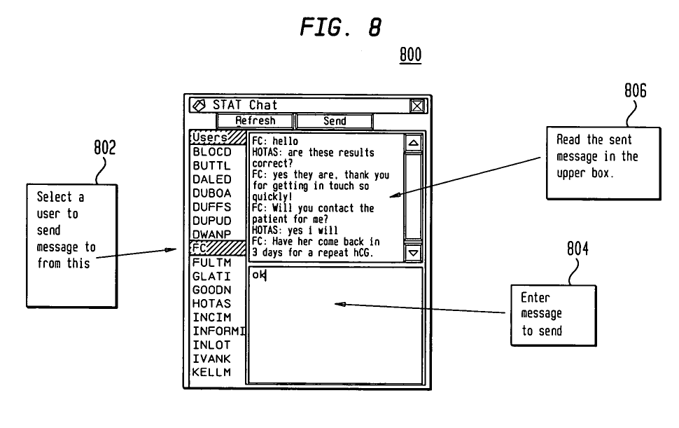

After the patient clinical data management application receives test results from the laboratory equipment 106, the user or the application itself may generate a report or a chart based on the received results. FIG. 7 illustrates an exemplary report of fertility-related test results. A user may also provide a real time message regarding test results to another user operating the endpoint device 120, the local computer 108 or one of the remote computers 114 and 116. FIG. 8 illustrates an exemplary GUI 800 wherein the user may select a recipient 802, enter a message 804 or read a message 806 from the other party.

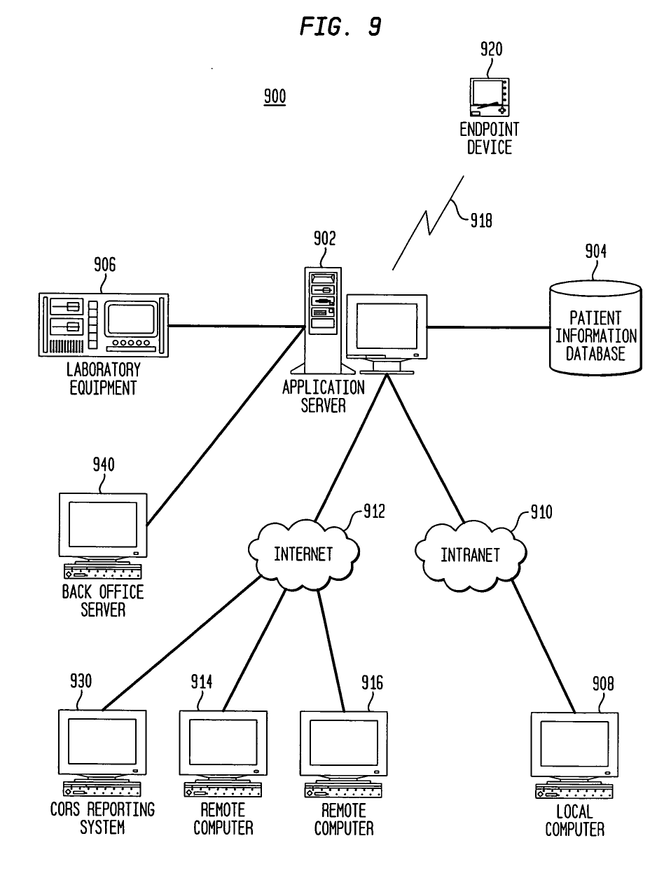

FIG. 9 illustrates a system 900 in accordance with another embodiment of the present invention. The system 900 includes many of the components of the system 100, having the same functionality as described above. For example, the system 900 includes an application server 902, a patient information database 904, laboratory equipment 906, a local computer 908, remote computers 914 and 916 and an endpoint device 920. The local computer 908 may connect to the application server 902 through an Intranet 910. Similarly, the remote computers 914 and 916 may connect to the application server 902 through the Internet 912. The remote computers 914 and 916 may be associated with one another or may operate separately as in, for example, one or more medical clinics. The endpoint device 920 preferably connects to the application server 902 via a network 918, which may be a wired or wireless network. Furthermore, the system 900 also includes a back office server 940 and a CORS reporting system 930.

The back office server 940 may contain hardware for sending and receiving information over the Internet and other networks. The back office server 940 may be a conventional application server or any computer network server or other automated system capable of communicating with other computers over a network. The back office server 940 may comprise one or more distributed processors.

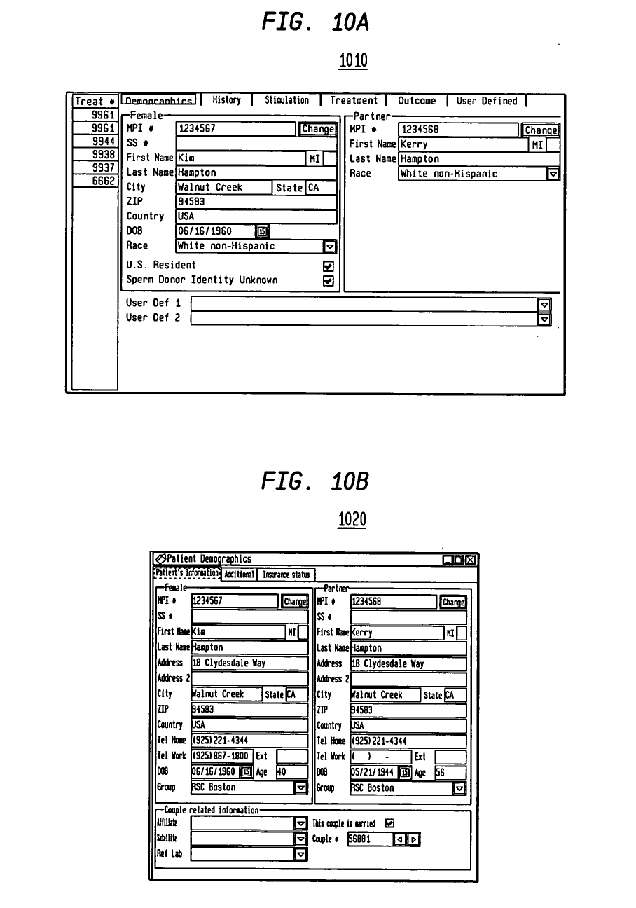

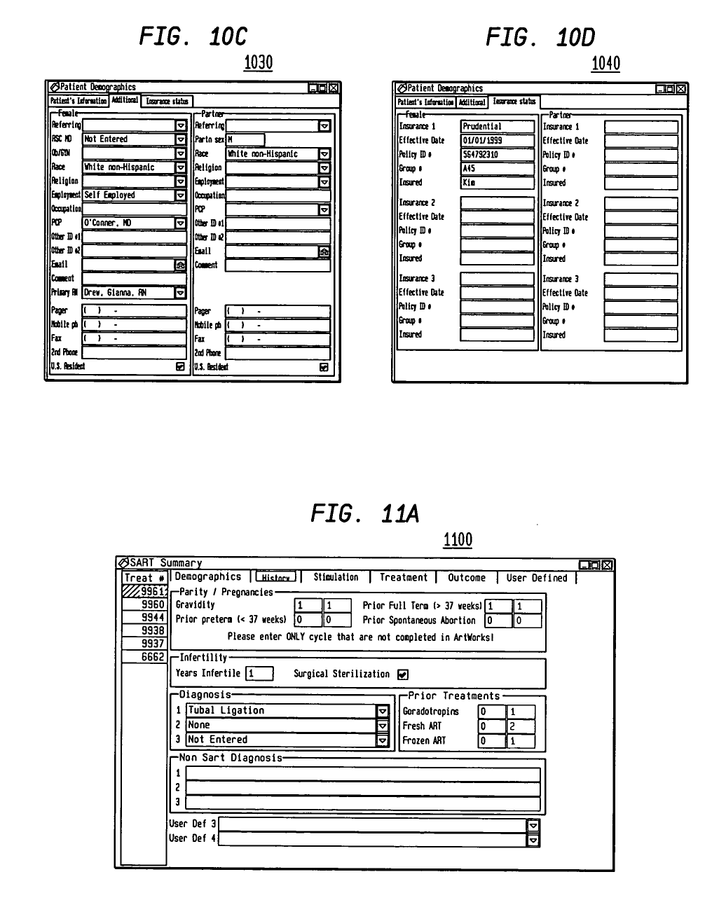

The back office server 940 is capable of handling “back office” functionality for billing, financing, insurance, demographic and other non-medical information related to patient information (“back office information”). For example, FIGS. 10A-D illustrate exemplary GUI screens 1010, 1020, 1030 and 1040, respectively, pertaining to demographic information. As shown in FIG. 10A, the GUI 1010 includes key identification information about a patient and her partner, such as full name, address, social security number (“SS #”), MPIs for the patient and the partner, date of birth (“DOB”) of the patient, race, etc. The GUI 1020 of FIG. 10B includes additional information such as home and work telephone numbers, which clinic or doctor's office serves the patient, and couple related information, such as whether they are married. The GUIs 1030 and 1040 contain supplemental information, including the referring physician, employment data and insurance information.

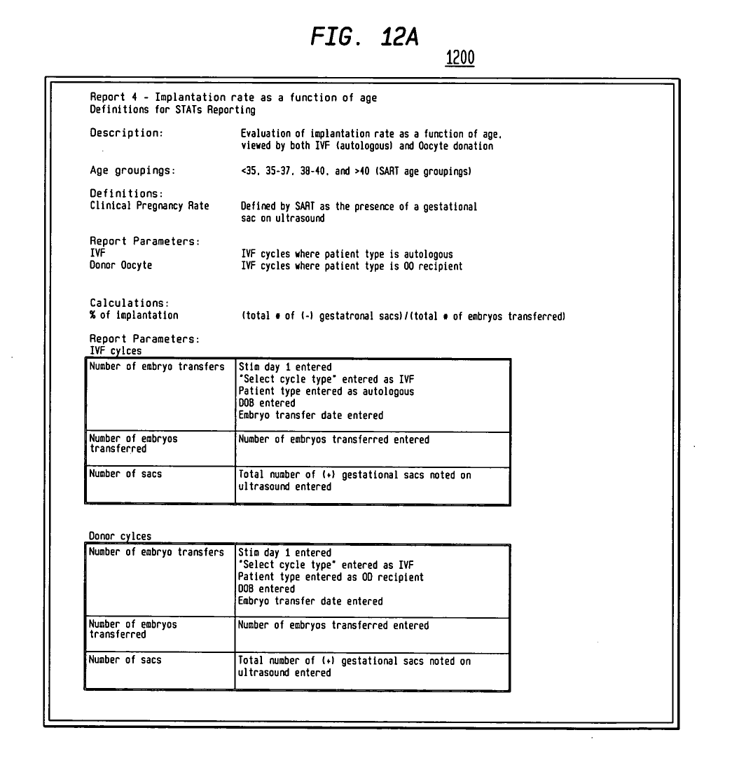

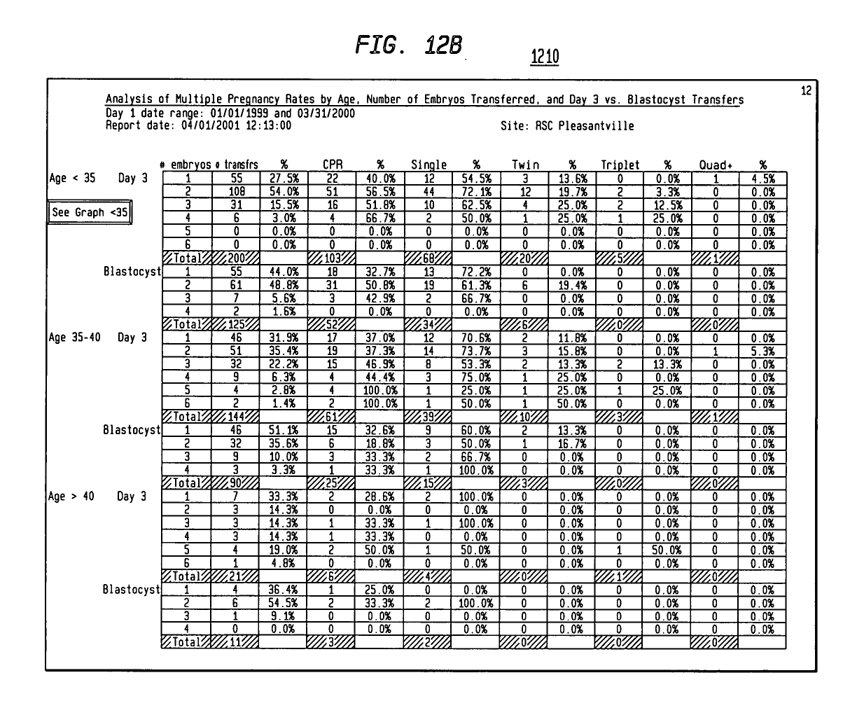

The back office server 940 preferably connects to the application server 902 directly in a point-to-point fashion, e.g., cabled together. More preferably, all demographic, insurance and referral data flow from the back office server 940 to the patient clinical data management application in this point-to-point fashion. The back office server 940 preferably includes back office application software to process the information. More preferably, the back office application software includes a financial application for processing at least the billing and other financial data. The back office server 940 may include a database for storing information pertaining to non-medical information. The back office application software is capable of exporting some or all of the back office information to the patient clinical data management application, which may store the back office information in the patient information database 904. Preferably, the back office information in the patient information database 904 is stored in such a way as to be associated with the patient information. The patient clinical data management application is preferably able to generate reports, charts and the like using the patient information, including any test results, as well as the back office information. For example, FIG. 12A illustrates an exemplary report 1200 detailing embryo implantation as a function of age, and FIG. 12B illustrates a statistical analysis 1210 for multiple pregnancy rates sorted according to various baseline criteria.

In one alternative, the patient clinical data management application is capable of coupling partner records with patient clinical data in the patient information database 904, as shown in FIGS. 10A-B. Coupling is important in many situations, such as generating a patient's chart. For example, when the system 900 is used in conjunction with a fertility clinic, a partner record may include information pertaining to the patient's husband, such as any infertility issues he may have encountered. Thus, after coupling a partner record with a specific patient's data, a user will be able to access information and document treatment for the patient and her partner on the patient clinical data management program.

The CORS reporting system 930 is preferably a server or other computer capable of reporting ART-related information to the CDC. The patient clinical data management application of the application server 902 preferably generates the ART-related information in a SART-compliant format based upon the information in the patient information database 904. The SART-compliant format may be the format defined by SART CORS, as is known in the art. For example, the patient clinical data management application may report SART-required ART data using a patient data table and a cycle table (e.g., a pregnancy cycle table). The SART-compliant information is preferably exported from the application server 902 to the CORS reporting system 930, which in turn provides this information to the CDC. Optionally, the CORS reporting system 930 may be integrated as part of the application server 902, or it may be an application resident on the application server 902.

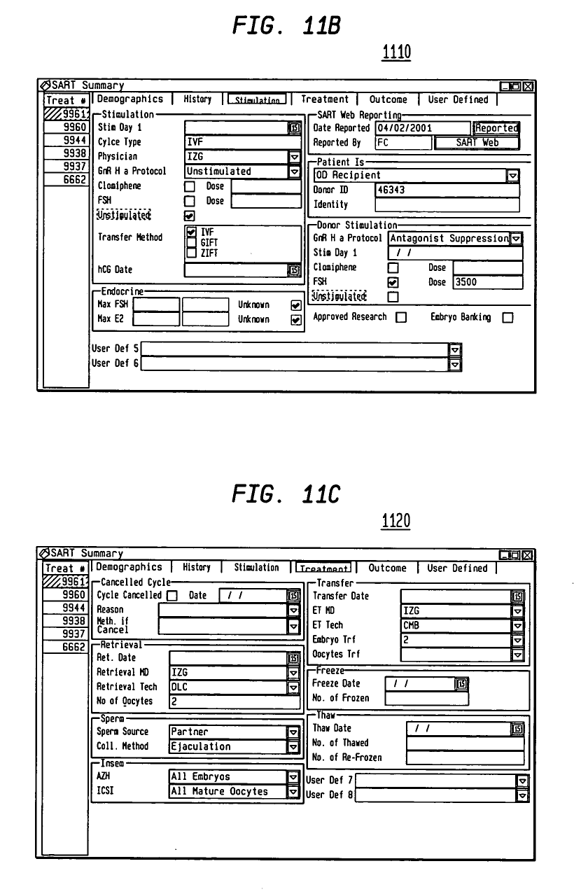

FIGS. 11A-C relate to SART information dealing with patient history, treatment and other ongoing activities. FIG. 11A illustrates a GUI 1100 for handling additional back office information related to patient history. In the case where the system 900 pertains to a fertility clinic, the GUI 1100 may include information concerning prior pregnancies or infertility problems, diagnoses and treatments. Similarly, FIG. 11B illustrates a GUI 1110 for stimulation management and related research. This information pertains to drug protocols for production of eggs or for transfer of embryos. FIG. 11C provides various options pertaining to infertility treatment, such as embryo fertilization, retrieval, freezing and thawing.

One advantage of the present invention is the use of multiple processes to generate test orders, automatically send the test orders to laboratory equipment and automatically receive test results from the laboratory equipment. Another advantage of the present invention is the use of barcode labels tied directly with the automatic ordering of tests and the processing of test results. Yet another advantage of the present invention is the ability to distribute test results to users at local computer, remote computers and endpoint devices upon receipt by the patient clinical data management application. A further advantage of the present invention is the ability to integrate back office data with patient clinical data to effectively manage patient records. Yet another advantage of the present invention involves using the patient clinical data management program to generate and transmit ART data in a SART-compliant format in order to comply with reporting requirements.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method for managing patient clinical data, the method comprising:
interfacing a central computer with laboratory equipment, the central computer having access to patient clinical data stored in a patient information database and the laboratory equipment being operable to generate test results based on medical tests;
receiving the test results at the central computer from the laboratory equipment;
storing the test results as a test results portion of the patient clinical data in the patient information database;
selecting a subset portion of the patient clinical data including data from the test results portion in accordance with a predetermined selection criterion; and
reporting the selected subset portion of the patient clinical data to a reporting device.

2. The method of claim 1, wherein interfacing the central computer with the laboratory equipment further includes sending a request to conduct the medical test from the central computer to the laboratory equipment.

3. The method of claim 1, wherein the laboratory equipment is controllable by a client computer remote from the central computer and the laboratory equipment.

4. The method of claim 1, wherein the test results generated by the laboratory equipment are received by a client computer remote from the laboratory equipment and the central computer, and the client computer is operable to transfer the test results to the central computer.

5. The method of claim 1, wherein the predetermined selection criterion is identified using one of a user-generated selection, a system-generated selection, or a bi-directional selection.

6. The method of claim 1, wherein the test results include endocrine test results for use in fertility treatment.

7. The method of claim 6, wherein the subset portion includes endocrine data from the endocrine test results.

8. The method of claim 1, wherein the reporting device is selected from the group consisting of a computer, a personal digital assistant, a wireless telephone, a pager and a website.

9. The method of claim 1, further comprising associating partner information with the patient clinical data such that a patient in the patient information database is linked with a partner, wherein a user can thereby obtain a report and document treatment for the patient and the partner.

10. The method of claim 1, wherein the predetermined selection criterion is a SART-compliant format, and the subset portion of the patient clinical data is reported according to the SART-compliant format.

11. The method of claim 1, further comprising:
obtaining back office information from a back office server; and
incorporating the back office information as a second portion of the patient clinical data in the patient information database, and wherein the subset portion further includes at least a portion of the back office information.

12. A computer-implemented method for managing patient clinical data, the method comprising:
sending a request to conduct a medical test from a central computer to laboratory equipment used in connection with patient testing, the central computer having access to patient clinical data that is stored in a patient information database;
receiving at the central computer test results from the laboratory equipment, the test results being based on the medical test;
storing the test results as a test results portion of the patient clinical data in the patient information database;
selecting a subset portion of the patient clinical data including data from the test results portion in accordance with a predetermined selection criterion; and
generating a report of the selected subset portion of the patient clinical data.

13. The method of claim 12, wherein the medical test is a test on a patient sample.

14. The method of claim 12, wherein the medical test is a batch of tests on a patient sample.

15. The method of claim 12, wherein the medical test is a test on a plurality of patient samples.

16. The method of claim 12, wherein the medical test is a batch of tests on a plurality of patient samples.

17. The method of claim 12, wherein the predetermined selection criterion is identified using one of a user-generated selection, a system-generated selection, or a bi-directional selection.

18. The method of claim 12, wherein the test results include endocrine test results for use in fertility treatment.

19. The method of claim 12, wherein the report is generated for a computer remote from the central computer.

20. The method of claim 12, wherein the report is generated for a wireless device.

21. The method of claim 12, wherein the report is electronically sent to a reporting system.

22. The method of claim 21, wherein the report is generated in a SART-compliant format, and the reporting system is a SART reporting system.

23. A system for managing patient clinical data, the system comprising:
a patient information database for storing patient clinical data;
laboratory equipment used in connection with patient testing, the laboratory equipment being operable to perform a medical test and generate test results based on the medical test; and
a central computer in communication with the laboratory equipment, the central computer including a patient clinical data management program capable of obtaining the test results from the laboratory equipment, storing the test results as a test results portion of the patient clinical data in the patient information database, selecting a subset portion of the patient clinical data including data from the test results portion in accordance with a predetermined selection criterion, and transmitting the subset portion of the patient clinical data to a reporting device.

24. The system of claim 23, wherein the central computer includes an application server for running the patient clinical data management program, and the system further comprises a client computer operable to access the patient clinical data management program by connecting to the application server.

25. The system of claim 24, wherein the test results are received from the laboratory equipment by the client computer, the client computer is operable to transfer the test results to the patient clinical data management program, and the client computer is remote from the laboratory equipment and the central computer.

26. The system of claim 23, wherein the test results include endocrine test results for use in fertility treatment.

27. The system of claim 23, wherein the reporting device is an endpoint device operable to interface with the central computer and receive the subset portion of the patient clinical data.

28. The system of claim 27, wherein the endpoint device is selected from the group consisting of a computer, a personal digital assistant, a wireless telephone, a pager and a website.

29. The system of claim 23, further comprising a back office server for managing back office information related to patient records, wherein the back office server is capable of providing the back office information to the central computer for use by the patient clinical data management program, and the patient clinical data management program is operable to incorporate the back office information as a second portion of the patient clinical data in the patient information database, wherein the subset portion further includes at least part of the second portion of the patient clinical data.

30. The system of claim 23, wherein the patient clinical data management program is capable of coupling partner information with the patient clinical data such that patients in the patient information database are correctly associated with partners.

31. The system of claim 23, further comprising a CORS reporting system, wherein the patient clinical data management application is capable of transmitting the subset portion of the patient clinical data to the CORS reporting system in a SART-compliant format.

32. A system for managing patient clinical data, the system comprising:
a patient information database for storing the patient clinical data;
laboratory equipment used in connection with patient testing, the laboratory equipment being operable to perform a medical test and generate test results based on the medical test; and
a central computer in communication with the laboratory equipment, the central computer having access to the patient information database and including a patient clinical data management program capable of sending a request to conduct the medical test to the laboratory equipment, receiving the test results from the laboratory equipment, storing the test results as a test results portion of the patient clinical data in the patient information database, selecting a subset portion of the patient clinical data including data from the test results portion in accordance with a predetermined selection criterion, and generating a report of the selected subset portion of the patient clinical data.

33. The system of claim 32, wherein the central computer includes an application server for running the patient clinical data management program, and the system further comprises a client computer operable to access the patient clinical data management program by connecting to the application server.

34. The system of claim 33, wherein the test results are received from the laboratory equipment by the client computer, the client computer is operable to transfer the test results to the patient clinical data management program, and the client computer is remote from the laboratory equipment and the central computer.

35. The system of claim 32, wherein the test results include endocrine test results for use in fertility treatment.

36. The system of claim 32, wherein the reporting device is an endpoint device operable to interface with the central computer and receive the subset portion of the patient clinical data.

37. The system of claim 36, wherein the endpoint device is selected from the group consisting of a computer, a personal digital assistant, a wireless telephone, a pager and a website.

38. The system of claim 32, further comprising a back office server for managing back office information related to patient records, wherein the back office server is capable of providing the back office information to the central computer for use by the patient clinical data management program, and the patient clinical data management program is operable to incorporate the back office information as a second portion of the patient clinical data in the patient information database, wherein the subset portion further includes at least part of the second portion of the patient clinical data.

39. The system of claim 32, wherein the patient clinical data management program is capable of coupling partner information with the patient clinical data such that patients in the patient information database are correctly associated with partners.

40. The system of claim 32, further comprising a CORS reporting system, wherein the patient clinical data management program is capable of transmitting the subset portion of the patient clinical data to the CORS reporting system in a SART-compliant format.

41. A computer-usable storage medium storing a program that is capable of instructing a processor to execute certain actions, the actions comprising:
interfacing a central computer with laboratory equipment, the central computer having access to patient clinical data stored in a patient information database and the laboratory equipment being operable to generate test results based on medical tests;
receiving the test results at the central computer from the laboratory equipment;
storing the test results as a test results portion of the patient clinical data in the patient information database;
selecting a subset portion of the patient clinical data including data from the test results portion in accordance with a predetermined selection criterion; and
reporting the selected subset portion of the patient clinical data to a reporting device.

42. A computer-usable storage medium storing a program that is capable of instructing a processor to execute certain actions, the actions comprising:
sending a request to conduct a medical test from a central computer to laboratory equipment used in connection with patient testing, the central computer having access to the patient clinical data that is stored in a patient information database;
receiving at the central computer test results from the laboratory equipment, the test results being based on the medical test;
storing the test results as a test results portion of the patient clinical data in the patient information database;
selecting a subset portion of the patient clinical data including data from the test results portion in accordance with a predetermined selection criterion; and
generating a report of the selected subset portion of the patient clinical data.
